(19) United States
(12) Patent Application Publication
(10) Pub. No.: US 2009/0078680 A1
(43) Pub. Date: Mar. 26, 2009

(54) ARC CHAMBER OF A HIGH-VOLTAGE SWITCH WITH A HEATING VOLUME OF VARIABLE SIZE

(75) Inventors: Christian Franck, Zurich (CH); Martin Seeger, Zurich (CH)

Correspondence Address: BUCHANAN, INGERSOLL & ROONEY PC, POST OFFICE BOX 1404, ALEXANDRIA, VA, 22313-1404, US

(73) Assignee: ABB Research Ltd., Zurich (CH)

(21) Appl. No.: 12/245,297

(22) Filed: Oct. 3, 2008

Related U.S. Application Data
(63) Continuation of application No. PCT/CH2007/000132, filed on Mar. 9, 2007.

(30) Foreign Application Priority Data
Apr. 5, 2006 (EP) 06405144.4

(51) Int. Cl. H01H 33/88

(52) U.S. Cl. 218/60

(57) ABSTRACT

An arc chamber is disclosed for a gas-insulated high-voltage switch. It contains a heating volume for accommodating compressed quenching gas from an arc zone. A part of the wall of the heating volume is formed by a piston which is displaceable against a restoring force. The piston is arranged as differential piston and has on its side facing away from the heating volume a piston step which forms a first working surface (A₂) acting in an expansion space and a second working surface (A₁-A₂) acting in an insulating-gas-filled storage space. Through the piston, a duct connecting the heating volume with the storage space is also conducted which is opened when the insulating-gas pressure (p₂) in the storage space is greater than the quenching-gas pressure (p₁) in the heating volume.

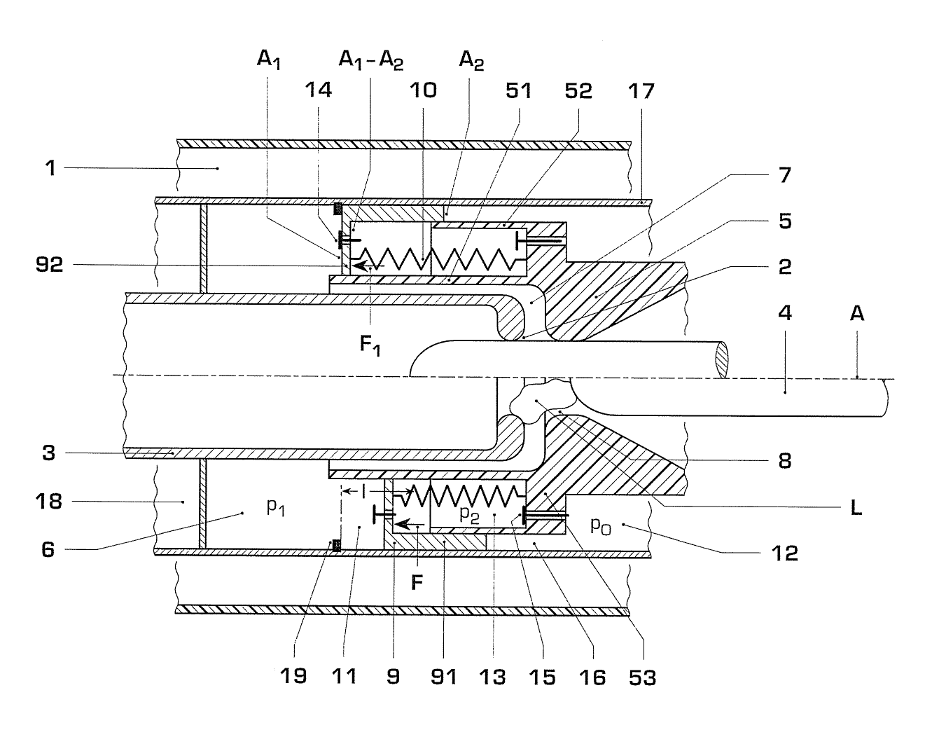

### RELATED APPLICATIONS

This application claims priority under 35 U.S.C. §119 to EP Application 06405144.4 filed in Europe on Apr. 5, 2006, and as a continuation application under 35 U.S.C. §120 to PCT/CH2007/000132 filed as an International Application on Mar. 9, 2007 designating the U.S., the entire contents of which are hereby incorporated by reference in their entireties.

### TECHNICAL FIELD

The present disclosure relates to an arc chamber of a high-voltage switch with a heating volume. The disclosure also relates to a switch having such an arc chamber.

### BACKGROUND INFORMATION

In a high-voltage conducting electrical network, the gas-insulated high-voltage switch is used for switching currents on and off, the intensity of which extends from very small inductive and capacitive currents via normal load currents up to medium and large short-circuit currents. To quench an arc formed during the switching off, an insulating gas having good arc quenching characteristics is used in this switch, which is compressed during the switching-off process and subsequently blows as quenching gas on the arc until it extinguishes at the zero transition of the current to be interrupted. The compression means used is a compression device activated by the switch drive and therefore needing drive energy and/or the switching arc itself, the energy of which is utilized for storing hot arc gases under pressure in a heating volume (so-called self blowing principle).

Switches operating in accordance with the self-blowing principle do not consume any drive energy and additionally advantageously conduct burn-up material of an insulating nozzle into the heating volume. The pressure and the temperature in the heating volume increase nonlinearly and almost as a square of the current intensity of the arc. Generally, a heating flow triggered by the switching arc and the size of the heating volume are optimally matched to currents of low and medium intensity since, when it is matched to currents of large amplitude, the heating current would otherwise be much too small in the case of small currents and could not build up a quenching gas pressure in the heating volume which would be sufficiently high to successfully blow the arc.

An arc chamber of the type initially mentioned with a flexibly constructed heating volume is described in DE 44 12 249 A1. A part of the boundary wall of the heating volume is formed by a piston which is supported displaceably against a restoring force in a hollow cylinder. The volume of the heating volume is dimensioned in such a manner that when small currents are switched off, a quenching gas pressure is built up in its interior which is sufficient for generally being able to successfully blow an associated low-power switching arc. During the switching off of a strong short-circuit current, a high quenching gas pressure is built up in the heating volume which displaces the piston in opposition to the restoring force and increases the heating volume. To blow the high-power switching arc, quenching gas of high pressure and high temperature is then available from an enlarged volume. In order to avoid a high counter pressure being built up in the hollow cylinder during the displacement of the piston, the hollow cylinder is connected to an expansion space of the arc chamber.

### SUMMARY

An arc chamber is disclosed of the type initially mentioned which, after being installed in a gas-insulated high-voltage switch, is distinguished by good switching capacity in spite of a low drive power.

An arc chamber for a gas-insulated high-voltage switch with an insulating-gas-filled housing in which two arc contacts movable relatively to one another along an axis are arranged, a heating volume, coaxially surrounding the two arc contacts, for accommodating compressed quenching gas from an arc space and a space for accommodating expanded quenching gas, a part of the wall of the heating volume being formed by a piston which is displaceable against a restoring force, wherein the piston is arranged as differential piston and has on the side facing away from the heating volume a piston step which forms a first working surface (A₂) acting in the expansion space and a second working surface (A₁ A₂) acting in an insulating-gas-filled storage space, and wherein a duct connecting the heating volume with the storage space is conducted through the piston, which is opened when the insulating-gas pressure (p₂) in the storage space is greater than the quenching-gas pressure (p₁) in the heating volume.

In another aspect, an arc chamber is disclosed for gas-insulated high-voltage switching. Such an arc chamber comprises a heating volume having a wall for accommodating compressed quenching gas from an arc zone; a displaceable piston forming a part of the wall of the heating volume, the piston being arranged as a differential piston and has on its side facing away from the heating volume a piston step which forms a first working surface acting in an expansion space and a second working surface acting in an insulating-gas-filled storage space; and a ducting connecting the heating volume with the storage space capable of conducting when an insulating-gas pressure in the storage space is greater than a quenching-gas pressure in the heating volume.

### BRIEF DESCRIPTION OF THE DRAWING

In the text which follows, an exemplary embodiment of the disclosure will be explained in greater detail with reference to the drawing. The single FIGURE shows a top view of a section conducted along an axis through an exemplary arc chamber according to the disclosure intended for a gas-insulated high-voltage switch, in which the arc chamber is shown with a closed switch above the axis and during the opening of the switch below the axis.

### DETAILED DESCRIPTION

In the exemplary arc chamber according to the disclosure, a piston forming a part of the wall of a heating volume is constructed as differential piston and has on its side facing away from the heating volume a piston step which forms a first working surface acting in an expansion space and a second working surface acting in an insulating-gas-filled storage space. Furthermore, a duct connecting the heating volume with the storage space, which is opened when the insulating-gas pressure in the storage space is greater than the quenching gas pressure in the heating volume is conducted through the piston.

When currents of low to medium intensity are switched off, there is therefore a generally sufficient quantity of arc-generating quenching gas available and then a low drive power is needed, if at all, for generating additional quenching gas in a compression device. When currents of medium to high amplitude are switched off, in contrast, the volume of the heating volume is increased with the supply of fresh insulating gas from the storage space. The density of the quenching gas provided in the heating volume is therefore kept at a high value required for good switch-off power, independently of the magnitude of the current to be switched off. This value corresponds to a density value which is achieved with a heating volume which is greater right from the start but the volume of which would be too great for generating a quenching gas pressure which has magnitude which is sufficient for successfully blowing an arc during the switching-off of small to medium currents.

The first working surface should be dimensioned in such a manner that the restoring force is lower above a limit value of the quenching gas pressure prevailing in the heating volume than a counterforce formed from the difference between quenching gas pressure and gas pressure in the expansion space. This dimensioning ensures that the piston can be displaced, enlarging the volume of the heating volume, and thus fresh insulating gas always enters from the storage space into the heating volume in the high-current phase of the current to be switched off.

The restoring force is generally generated by a compression spring acting on the piston which is arranged in a simple production process in the storage space or in the expansion space.

A constant supply of fresh gas from the storage space into the heating volume and thus a high density of the quenching gas is ensured during the switching of medium to large currents when the force of the compression spring over a displacement path of the piston limited by two stops is less than a differential force A₂·(p₁−p₀), acting on the piston in the high-current phase of the current to be switched off, where p₁ is the gas pressure generated by the work of a switching arc in the heating chamber, p₀ is the gas pressure in the expansion space and A₂ is the size of the first working surface.

To save space and thus to keep the dimensions of the arc chamber small, the first working surface is formed by an axially extended piston projection and the expansion space contains an axially aligned part-space in which the first working surface is carried displaceably. If the piston projection is arranged to be tubular and if the part-space has a volume arranged as hollow cylinder, the arc chamber is distinguished by great operating reliability since operationally important characteristics such as, in particular, the gas density, the mechanical and the dielectrical strength and the current carrying capability are optimized by simple means. If the outer surface of the hollow cylinder is formed by a metal tube limiting the heating volume to the outside and the inside surface is formed by the insulating nozzle, components existing in any case can be used for cost-effective production of the arc chamber.

If a return valve is arranged in a connection provided between the storage space and the expansion space, which is blocked when an overpressure forms in the storage space, the storage space can be rapidly filled again with fresh insulating gas after a switching-off process.

The arc chamber, shown in the single FIGURE, of a high-voltage power switch contains a housing 1 filled with a compressed insulating gas, for instance based on sulfurhexafluoride, nitrogen, oxygen or carbon dioxide or of mixtures of these gases with one another, for example air, and a contact arrangement 2, constructed predominantly axially symmetrical, accommodated by the housing 1 and held by the housing, with two arc contacts 3, 4 movable relatively to one another along an axis A. The arc contact 3 can be moved along the axis A whereas the arc contact 4 is generally kept stationary in the housing 1 but may also be displaced along the axis, if necessary. The two arc contacts 3, 4 are coaxially enclosed by an insulating nozzle 5 and a heating volume 6 for storing quenching gas. The heating volume 6 is arranged in the manner of a toroid having a rectangular cross section in the circumferential direction. In the case of a switch intended for nominal voltages of typically 200 to 300 kV and for a nominal short-circuit switching-off current of typically 50 to 70 kA, the heating volume 6 can generally accommodate approx. 1 to 2 liters of quenching gas under pressure. Into the heating volume 6, a heating duct 7 opens which, when the switch is opened, connects an arc zone 8 formed by separating the burn-up contacts 3, 4 during the opening of the switch, and limited radially by the insulating nozzle 5, to the heating volume 6. A part of the wall of the heating volume 6 is formed by a differential piston 9 which can be displaced against a restoring force F provided by a compression spring 10 in gastight manner in an axially-symmetrically arranged ring space 11.

The piston 9 has on its side limiting the heating volume 6 an annular working surface, characterized by the reference symbol A₁, with an effective cross section of size A₁. On the side facing away from the heating volume 6, it is constructed to be step-shaped and contains a piston step, formed by a tube connection 91 which forms two working surfaces A₂ and A₁-A₂ in each case having an effective cross section A₂ and A₁-A₂, respectively. The working surface A₂ acts in an expansion space 12 in which the insulating gas has a pressure p₀ whereas the piston surface A₁-A₂ acts in a storage space 13 filled with fresh insulating gas. In the piston 9, a duct which can be closed by a non-spring-loaded return valve 14, not designated for reasons of clarity, is arranged which connects the heating volume 6 to the storage space 13.

The storage space 13 is constructed as annular chamber and is radially limited by two coaxially arranged hollow cylinders and axially by two front bodies. The hollow cylinder lying on the inside is formed by a tubular piston projection 51 molded into the insulating nozzle 5, which limits an axially conducted section of the heating duct 7 toward the outside. The outside hollow cylinder is formed by two telescopically displaceable tubular projections 52 and 91, of which the projection 52 is also molded into the insulating nozzle 5 whereas the projection 91 is molded into the piston 9. The two front bodies provided for the axial limiting are formed, on the one hand, by a radially conducted section 92 of the piston 9 and, on the other hand, by a radially conducted section 53 of the insulating nozzle 5. The piston section 92 forms the working surface A₁-A₂. The compression spring 10 is arranged in the storage space 13 and is supported with one end on the section 92 and the other end on the section 53. In a connection, molded into the section 53, between the expansion space 12 and the storage space 13, a return valve 15 is arranged which is aligned in such a manner that it is blocked when an overpressure forms in the storage volume 13.

The working surface A₁ is formed by the piston projection 91 and is carried displaceably in an axially aligned part-space 16 of the expansion space 12. The part-space 16 evidently has a volume constructed as hollow cylinder. The outer surface of the hollow cylinder is formed by a metal tube 17 limiting the heating volume 6 toward the outside and generally used for conducting operating currents but the inside surface is formed by the parts 52, 53 of the insulating nozzle 5.

In the switched-on position of the chamber, shown in the upper half of the FIGURE, the left-hand end of the arc contact 4 is pushed in current-conducting manner into the right-hand end of the tubularly constructed arc contact 3. When a current is switched off, the two arc contacts 3, 4 separate from one another and during this process, an arc L based at the two ends of the arc contacts is formed which generates high-pressure hot gases in the arc zone 8. The temperature and the pressure of the arc gases are determined by the arc work and are therefore proportional to the duration of the arc time determined by the zero transition of the current and approximately proportionate to the square of the current to be switched off.

The pressure of the arc gases in the arc zone 8 is generally greater than in the heating volume 6. In the heating duct 7, hot gas therefore flows from the arc zone 8 into the heating volume 6. If the heating effect of the arc L decreases when it approaches the zero transition of the current, a flow reversal occurs. Gas with a pressure p₁, stored in the heating volume 6 flows as quenching gas via the heating duct 7 into the arc zone 8 and there blows on the arc L at least as long until it is quenched at the zero transition of the current.

The volume of the heating volume 6 is determined in such a manner that, when small to medium currents are switched off, a generally sufficient quantity of compressed quenching gas is available for arc extinction in the heating volume 6. Additional quenching gas can be fed in from a compression space 18, connected to the heating volume 6 at low quenching gas pressure p₁, of a slightly dimensioned piston/cylinder compression device. The piston 9 is then conducted against a stop 19 held at the metal tube 17 under the restoring force of a slightly pre-tensioned compression spring 10. The pre-tension force F₁ of the spring is adjusted in such a manner that it holds the piston 9 at the stop 19 below a limit value p₁^{G} of the quenching gas pressure p₁ in the heating volume 6. When the piston 9 is undisplaced, the return valve 15 is opened. The storage space 13 is then connected to the expansion space 12 filled with insulating gas, in which the insulating gas is held at a pressure p₀. The pre-tension force F₁ must therefore be A₁·(p₁^{G}−p₀).

At currents of medium to large amplitude, p₁ exceeds the limit value pressure p₁^{G}. The piston 9 is then displaced toward the right so that during this process the pressure p₂ in the storage space 13 increases with respect to the pressure p₀ in the expansion space and the return valve 15 is now closed. As soon as the pressure p₂ in the storage space 13 exceeds the pressure p₁ in the heating volume 6, the return valve 14 opens and fresh insulating gas flows from the storage space 13 into the heating volume 6. This keeps the density of the gas in the heating volume 6 at a required high value. This value corresponds to that which is achieved by a heating volume which is greater right from the start but the volume of which would be too great in order to achieve a quenching gas pressure p₁ which is sufficient for successfully blowing the arc at currents of small to medium amplitude.

Depending on the magnitude of the pressure p₁ in the heating volume 6, the piston is displaced more or less far to the right. The movement of the piston 9 to the right is limited by a stop formed by projection 52. Over the path of length I determined by the stop 20 and the projection 52, a force produced by the piston 9 must be greater than the restoring force F produced by the compression spring 10. The force generated by the piston 9 by the differential effect of pressures p₁ in the heating volume 6 and p₀ in the part-space 12 is A₂·(p₁−p₀). The piston surface A₂ should therefore be dimensioned in such a manner that the spring force F prevailing at a location on the path is lower than or at the most equal to the differential force acting at the piston 9 over the entire path I. This ensures that p₂ is greater than p₁ over the entire displacement path I and thus a quenching gas of greater density is formed in the heating volume 6 than in a switch according to the prior art in which, although the piston increases the volume of the heating volume by displacement, it considerably reduces the quality of the quenching gas by reduction of the quenching gas density.

Due to the blowing on the switching arc L at the zero transition of the current, the quenching gas pressure p₁ drops in the heating volume 6. The restoring force F of the compression spring 10 then prevails over the differential force and returns the piston 9 into its initial position in which it is carried against the stop 19. Fresh insulating gas can then enter from the expansion space 12 via the return valve 15, which is now open, into the storage space 13.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE DESIGNATIONS

1 Housing
2 Contact arrangement
3, 4 Contact pieces
5 Insulating nozzle
6 Heating volume
7 Heating duct
8 Arc zone
9 Piston
10 Compression spring
11 Annular space
12 Expansion space
13 Storage space
14, 15 Return valves
16 Part-space
17 Metal tube
18 Compression space
19 Stop
51, 52 Projections of the insulating nozzle
53 Section of the insulating nozzle
91 Piston projection
92 Piston section
A Axis
A₁, A₂, A₁-A₂ Working surfaces on the piston
F Restoring force
F₁ Pre-tension force
L Arc
p₀ Gas pressure in the expansion space
p₁ (Quenching) gas pressure in the heating volume
p₂ (Insulating) gas pressure in the storage space
I Maximum length of the displacement path of the piston

What is claimed is:

1. An arc chamber for a gas-insulated high-voltage switch with an insulating-gas-filled housing in which two arc contacts movable relatively to one another along an axis are arranged, a heating volume, coaxially surrounding the two arc contacts, for accommodating compressed quenching gas from an arc space and a space for accommodating expanded quenching gas, a part of the wall of the heating volume being formed by a piston which is displaceable against a restoring force, wherein the piston is arranged as differential piston and has on the side facing away from the heating volume a piston step which forms a first working surface (A₂) acting in the expansion space and a second working surface (A₁-A₂) acting in an insulating-gas-filled storage space, and wherein a duct connecting the heating volume with the storage space is conducted through the piston, which is opened when the insulating-gas pressure (p₂) in the storage space is greater than the quenching-gas pressure (p₁) in the heating volume.

2. The arc chamber as claimed in claim 1, wherein the first working surface (A₂) is dimensioned in such a manner that above a limit value of the quenching gas pressure (p₁) prevailing in the heating volume, the restoring force is lower than a counterforce formed from the difference between quenching gas pressure (p₁) and gas pressure (p₀) in the expansion space.

3. The arc chamber as claimed in claim 2, wherein in the storage space, a compression spring acting on the piston (is arranged for generating the restoring force.

4. The arc chamber as claimed in claim 3, wherein the compression spring is arranged in the expansion space instead of the storage space.

5. The arc chamber as claimed in claim 3, wherein the force of the compression spring over a displacement path of the piston, limited by two stops, is smaller than a differential force A₁·(p₁−p₀) acting on the piston, wherein
p₁ is the gas pressure generated by the work of a switching arc in the heating chamber,
p₀ is the gas pressure in the expansion space, and
A₂ is the size of the first working surface (A₂).

6. The arc chamber as claimed in claim 1, wherein the first working surface (A₂) is formed by an axially extended piston projection and wherein the expansion space contains an axially aligned part-space in which the first working surface (A₂) is carried displaceably.

7. The arc chamber as claimed in claim 6, wherein the piston projection is arranged to be tubular and wherein the part-space has a volume arranged as hollow cylinder.

8. The arc chamber as claimed in claim 7, wherein the outer surface of the hollow cylinder is formed by a metal tube limiting the heating volume toward the outside, and the inside surface is formed by the insulating nozzle.

9. The arc chamber as claimed in claim 1, wherein in a connection provided between the storage space and expansion space, a return valve is arranged which is blocked when an overpressure forms in the storage space.

10. A high-voltage switch comprising an arc chamber as claimed in claim 1.

11. The arc chamber as claimed in claim 4, wherein the force of the compression spring over a displacement path of the piston, limited by two stops, is smaller than a differential force A₁·(p₁-p₀) acting on the piston, wherein
p₁ is the gas pressure generated by the work of a switching arc in the heating chamber,
p₀ is the gas pressure in the expansion space, and
A₂ is the size of the first working surface (A₂).

12. The arc chamber as claimed in claim 5, wherein the first working surface (A₂) is formed by an axially extended piston projection and wherein the expansion space contains an axially aligned part-space in which the first working surface (A₂) is carried displaceably.

13. The arc chamber as claimed in claim 8, wherein in a connection provided between the storage space and expansion space, a return valve is arranged which is blocked when an overpressure forms in the storage space.

14. A high-voltage switch comprising an arc chamber as claimed in claim 9.

15. An arc chamber for gas-insulated high-voltage switching, comprising:
a heating volume having a wall for accommodating compressed quenching gas from an arc zone;
a displaceable piston forming a part of the wall of the heating volume, the piston being arranged as a differential piston and has on its side facing away from the heating volume a piston step which forms a first working surface acting in an expansion space and a second working surface acting in an insulating-gas-filled storage space; and
a ducting connecting the heating volume with the storage space capable of conducting when an insulating-gas pressure in the storage space is greater than a quenching-gas pressure in the heating volume.

16. The arc chamber as claimed in claim 15, wherein when currents of medium to large amplitude are switched off, the heating volume is increased with a supply of fresh quenching gas from the storage space, thereby the density of the quenching gas provided in the heating volume facilitates good switching despite the magnitude of the current to be switched off.
